(19) United States
(12) Patent Application Publication
(10) Pub. No.: US 2012/0124753 A1
(43) Pub. Date: May 24, 2012

(54) Zoned foam mattress with alternating lateral regions of HD foam and memory foam

(75) Inventor: Youn Jae Lee, Pleasanton, CA (US)

(73) Assignee: Zinus Inc.

(21) Appl. No.: 12/927,654

(22) Filed: Nov. 19, 2010

(51) Int. Cl. A47C 27/15; B23P 11/00

(52) U.S. Cl. 5/727; 29/428

(57) ABSTRACT

A zoned foam mattress includes an upper foam layer and a zoned foam layer. The lower side of the upper foam layer is adjacent to the upper side of the zoned foam layer. The zoned foam layer has first, second and third lateral regions with the second region being disposed between the first region and the third region. The first lateral region is disposed at the head end of the mattress. The first and third lateral regions are formed from high-density polyurethane foam (HD foam), whereas the second lateral region is formed from visco-elastic polyurethane foam (memory foam). A person's shoulder can sink farther into the second lateral region than into the first or third lateral regions even if all of the lateral regions have the same indentation load deflection (ILD). By allowing a person's shoulders and hips to sink into memory foam regions, the person's spine is kept straight.

### TECHNICAL FIELD

The present invention relates to mattresses, and in particular to a zoned mattress that enhances a user's quality of sleep.

### BACKGROUND INFORMATION

A comfortable mattress is crucial to providing high quality sleep. Defining the characteristics of a comfortable mattress, however, is not a trivial matter. In fact, the characteristics of a mattress that are generally accepted to provide comfort and thereby a high quality of sleep have changed over time. Mattresses were previously described as being “too hard” or “too soft.” More recently, more specific characteristics of mattresses are used to provide a better assessment of the qualities of a mattress to provide comfort. For example, foam mattresses typically now have multiple foam layers and multiple lateral zones. Each foam layer and zone has unique characteristics that are described more specifically than merely being hard or soft. The foam of each layer and zone is described as having certain characteristics, such as a density, an indentation load deflection (ILD), a compression load deflection (CLD), an initial softness ratio (ISR), a compression modulus, a resilience (elasticity) and a hysteresis.

The density is merely the mass per unit volume of the foam. For example, a high-density foam might have a density of 50 kg/cubic meter. Higher density foam is more likely to maintain its hardness with repeated use. The indentation load deflection (ILD) is one measure of hardness defined in the ISO 2439 standard. The standard defines ILD as the force that is required to compress the foam to a specified percentage of its original thickness using a circular plate of 50 square inches (322 cm²). For example, the ILD at 25% compression is the number of pounds required to achieve the 25% compression. ILD is also measured at 40% and 60% compression. The compression load deflection (CLD) is another hardness measurement defined in the ISO 3386 standard. CLD is defined as the counterpressure after the foam is pressed in 25%. The initial softness ratio (ISR) is a third hardness measurement defined as the ratio of the ILD at 65% compression to the ILD at 5% compression. The ISR attempts to quantify the perceived comfort when a person first lies down on a foam mattress. The compression modulus is a sag factor defined in the ISO 2439 standard as the ratio of the ILD at 65% compression to the ILD at 25% compression. The compression modulus attempts to quantify the degree to which the foam mattress supports the user in a uniform alignment. Resilience is an elasticity measurement defined in the ASTM 3574 standard based on the height that a predefined ball rebounds after being dropped on the foam mattress from a specified height. Resilience is measured as a percentage of the specified height. Hysteresis measures the force required to deform the surface of the foam as a force is loaded and unloaded from the mattress. The hysteresis represents the amount of energy that is absorbed by the foam. The more energy that is absorbed by the foam, the more energy is required by a person lying on the foam to change position. Generally, softer foam results in a lower hysteresis, which requires a person to expend more energy to change position and results in lower quality sleep.

Despite the realization that the characteristics of a foam mattress are much more complex than merely being hard or soft, zoned foam mattresses are currently designed primarily based on the hardness of the foam zones, as defined by the indentation load deflection (ILD). Considering that foam has characteristics other than its hardness as measured by the ILD, a design for a zoned foam mattress is sought that provides a higher quality of sleep than does a mattress that merely alternates hard and soft zones as characterized by different ILDs.

### SUMMARY

A zoned foam mattress permits a person's spine to remain straight when the person's shoulders and hips sink farther into memory foam zones of the mattress than the person's head, torso and legs sink into HD foam zones of the mattress. The zoned foam mattress includes an upper foam layer, a zoned foam layer and a bottom foam layer. The lower side of the upper foam layer is adjacent to the upper side of the zoned foam layer. A plurality of cylindrical holes are distributed throughout the upper foam layer. In one embodiment, the cylindrical holes pass entirely through the upper foam layer. In another embodiment, the holes penetrate only partly down into the upper foam layer.

A person reclining on the zoned foam mattress lies directly on the upper layer through a thin quilted fiber padding sewn to a mattress cover. The zoned foam layer has a first, a second and a third lateral region. The first lateral region is disposed at the head end of the zoned foam mattress. The second lateral region is disposed between the first lateral region and the third lateral region. The first and third lateral regions are formed from high-density polyurethane foam (HD foam), whereas the second lateral region is formed from visco-elastic polyurethane foam (memory foam). Even where each of the lateral regions has the same indentation load deflection (ILD), a person's shoulder will sink farther into the second lateral region than into the first or third lateral regions. By allowing a person's shoulders and hips to sink into the memory foam regions and by supporting the person's head, torso and legs above HD foam regions, the person's spine is kept straight.

In one embodiment, each of the first, second and third lateral regions has the same ILD. In another embodiment, the second lateral region has a lower ILD than do the first lateral region and the third lateral region. The bottom foam layer has a higher ILD than does the first lateral region.

A method of manufacturing the zoned foam mattress includes forming three lateral regions of a zoned foam layer. First and third lateral regions are formed from high-density polyurethane foam (HD foam). A second lateral region is formed from visco-elastic polyurethane foam (memory foam). In one embodiment, the memory foam is heat sensitive. The first lateral region is disposed at the head end of the zoned foam layer, and the second lateral region is disposed between the first lateral region and the third lateral region. A plurality of cylindrical holes are punched vertically down through an upper foam layer. The lower side of the upper foam layer is placed on top of the upper side of the zoned foam layer. The lower side of the zoned foam layer is placed on the upper side of a bottom foam layer. Even where each of the first, second and third lateral regions has the same ILD, the second lateral region is adapted to allow a person's shoulders to sink into the mattress so as to keep the person's spine straight.

In another embodiment, a zoned foam mattress includes an upper foam layer and a zoned foam layer. The lower side of the upper foam layer is adjacent to the upper side of the zoned foam layer. All parts of the upper foam layer exhibit the same ILD. The zoned foam layer includes a first zone and a second zone that are both made of HD foam. In addition, the zoned foam mattress includes means for allowing a person's shoulder to sink farther into a shoulder zone of the zoned foam layer than into the first zone or the second zone. The shoulder zone lies between the first zone and the second zone. In one aspect, the first zone, the second zone and the shoulder zone all have the same ILD. The means allows the person's shoulder to sink into the shoulder zone such that the person's spine is kept straight. In another aspect, the means is made of heat sensitive foam.

Further details and embodiments are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a cut-away perspective view of a novel mattress with alternating lateral zones of memory foam and HD foam.

FIG. 2 is a cross-sectional view of the zoned foam mattress of FIG. 1 showing various regions of a zoned foam layer.

FIGS. 3A-C are diagrams illustrating how HD foam and memory foam of the same ILD provide different support.

FIGS. 4-5 are more detailed cross-sectional views of the lateral regions towards the head end of the mattress of FIG. 1 with and without a recumbent person's shoulder sinking into one of the lateral regions.

FIGS. 6A-B are cross-sectional views that compare the characteristics of a mattress with a middle layer having alternating lateral HD and memory foam regions to a mattress with a middle layer made entirely of HD foam.

FIG. 7 is a cross sectional view of the entire zoned foam mattress of FIG. 6A on which a person's spine remains straight when the person's shoulders and hips sink farther into lateral memory foam regions.

FIG. 8 is a flowchart of steps of a method of making the zoned foam mattress of FIG. 1 with alternating lateral regions of HD foam and memory foam.

### DETAILED DESCRIPTION

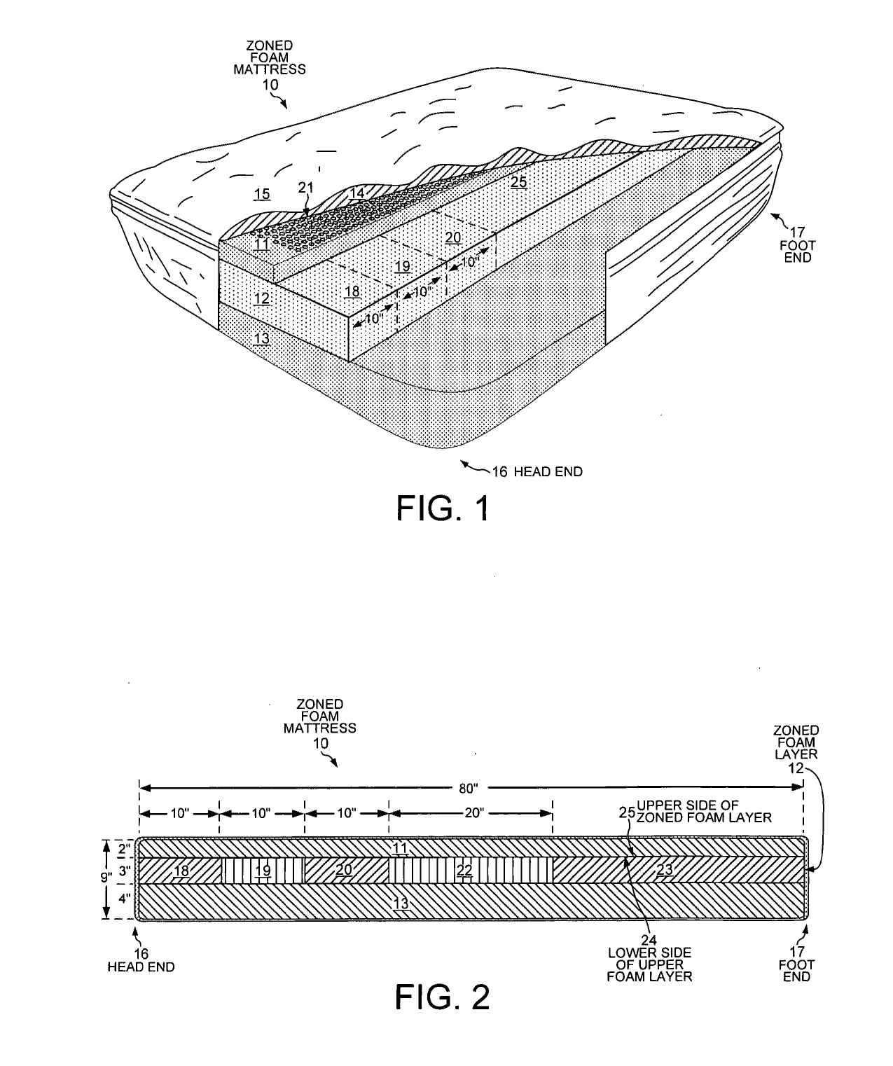

FIG. 1 is a cut-away perspective view of a novel zoned foam mattress 10. Mattress 10 includes an upper foam layer 11, a zoned foam layer 12, and a bottom foam layer 13. Upper foam layer 11 is made of visco-elastic polyurethane foam, otherwise known as memory foam. A person using mattress 10 lies directly on upper layer 11 through a thin quilted fiber padding 14 sewn to the mattress cover 15. Bottom foam layer 13 provides support for the other layers and is made of “high density” polyurethane (HD) foam. The “high density” foam is somewhat of a misnomer because upper layer 11 of memory foam has a higher density than does the HD foam. Typically, the HD foam used in mattresses has a density of between 1.5 to 2.5 pounds per cubic foot, whereas memory foam typically has a density between three and 5.5 pounds per cubic foot. Zoned foam layer 12 rests on bottom foam layer 13. Zoned foam layer 12 includes longitudinally spaced, transversely extending lateral regions of foam. The lateral regions alternate between HD foam and memory foam. Memory foam is temperature sensitive. At room temperature memory foam is harder than at skin temperature. Memory foam softens on contact and molds itself to the shape of a warm body within a few minutes. As a person lies on memory foam, the foam becomes softer, more pliant and more elastic.

In one embodiment, zoned foam mattress 10 is a Queen size mattress that is sixty inches wide and eighty inches from the head end 16 to the foot end 17 of mattress 10. Zoned foam layer 12 has a first lateral region 18 located at the head end 16 of mattress 10. First lateral region 18 is about ten inches long. Zoned foam layer 12 also has a second lateral region 19 adjacent to first lateral region 18. A third lateral region 20 is adjacent to second lateral region 19. Second lateral region 19 is disposed between first lateral region 18 and third lateral region 20. Each of second and third lateral regions 19-20 is also about ten inches long. The average consumer, regardless of body height, sleeps with his or her head at the same distance from the head end of the mattress. Thus, the average North American consumer sleeps with his or her shoulders about fifteen inches from the head end of the mattress. The middle of second lateral region 19 is about fifteen inches from head end 16 of mattress 10.

Cylindrical holes 21 penetrate vertically through upper layer 11 of memory foam. The holes 21 cover the entire surface of layer 11 except for a frame around the perimeter of layer 11 that is several inches wide. People tend to perspire more while sleeping on memory foam than while sleeping on a spring mattress because air does not circulate as well through the foam. The vertical holes 21 allow air to reach the body of a person lying on mattress 10 and permit cooler sleeping. In addition to enhancing air circulation, the holes 21 also make upper layer 11 somewhat softer. The frame is maintained around the perimeter of layer 11 without holes in order to provide better edge support for a person sitting at the end of the mattress.

FIG. 2 is a cross-sectional view of zoned foam mattress 10 showing the various regions of zoned foam layer 12. For an 80-inch-long Queen size mattress, a fourth lateral region 22 is about twenty inches wide and is adjacent to third lateral region 20. A fifth lateral region 23 at foot end 17 of zoned foam layer 12 is thirty inches long. Upper foam layer 11 has a lower side 24 that is adjacent to an upper side 25 of zoned foam layer 12. The embodiment of mattress 10 shown in FIG. 2 is nine inches thick. Upper layer 11 is two inches thick; zoned foam layer 12 is three inches thick; and bottom layer 13 is four inches thick.

The typical user of mattress 10 sleeps with his or her shoulders in the middle of second lateral region 19 about fifteen inches from head end 16. The hips of a typical user rest somewhere above fourth lateral region 22. Although all of the regions of zoned foam layer 12 have the same indentation load deflection (ILD), the shoulders and hips of the user sink deeper into regions 19 and 22, respectively, and are supported better by those regions because those regions are formed from visco-elastic polyurethane foam (memory foam), whereas the remaining regions are formed from high-density polyurethane foam (HD foam). In another embodiment, the remaining regions are formed from natural latex rubber as opposed to HD foam.

However, it is not at all intuitive that a person's shoulder would sink deeper, for example, into second lateral region 19 than into first lateral region 18 or third lateral region 20 if all three regions have the same ILD. HD foam and memory foam, however, support a sleeping person's shoulder differently than they support a cold 8-inch diameter metal disk as specified by the ISO 2439 standard. First, a person's shoulder is more pointed than an 8-inch disk, and a point sinks deeper into memory foam than into HD foam. Second, memory foam is heat sensitive and has a lower ILD at higher temperature. As a person lies on memory foam, the foam becomes softer, more pliant and more elastic. Thus, over time, a sleeping person's shoulder sinks deeper into memory foam than into HD foam having the same initial ILD. Third, memory foam has a higher elasticity than does HD foam. Consequently, memory foam provides better support because memory foam hugs the body shape closer than does HD foam of the same ILD.

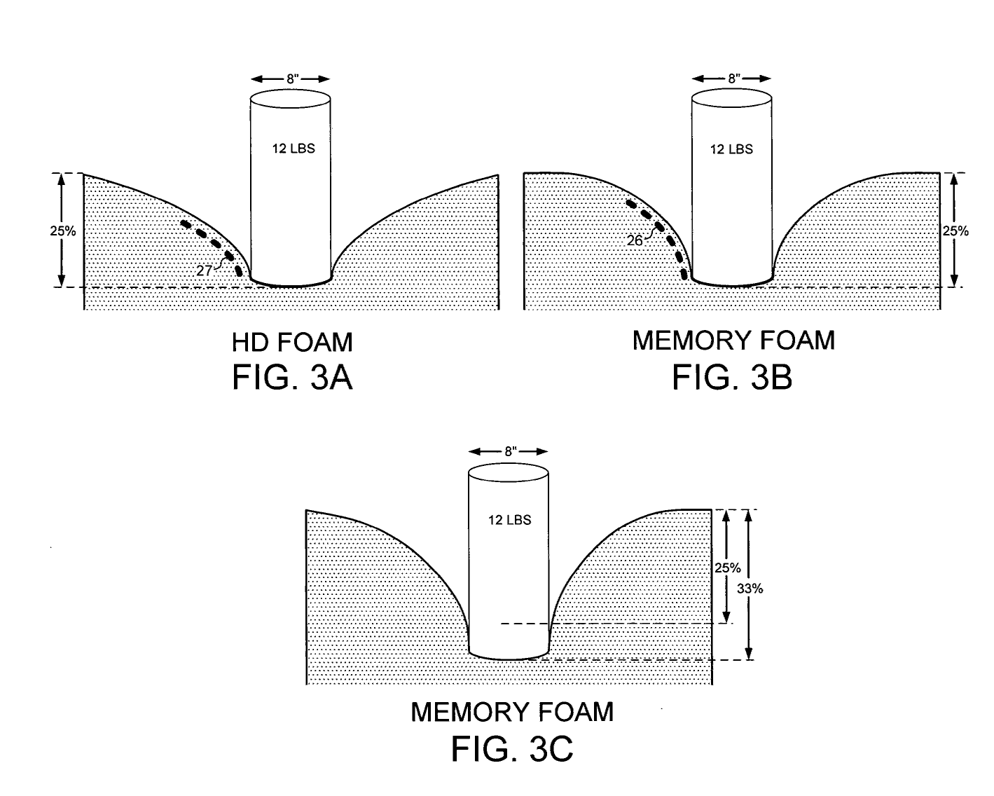

FIGS. 3A-C illustrate how HD foam and memory foam of the same ILD provide different support. Each of FIGS. 3A-C shows foam exhibiting a twelve ILD at 25% compression, in other words, twelve pounds of pressure is required to press an 8-inch-diameter steel test plate one inch into a 4-inch thick sample slab of foam. Yet the memory foam shown in FIGS. 3B-C hugs a person's shoulders and hips better than HD foam and allows the point of a person's shoulders to sink deeper into the foam. FIG. 3B illustrates that memory foam is more elastic than is the HD foam shown in FIG. 3A. There is a greater curvature 26 of the surface of the memory foam as a 12-pound, 8-inch cylinder sinks 25% into the thickness of the foam than the curvature 27 of the surface of HD foam in the same twelve ILD test. The cylinder is hugged more by the memory foam than by the HD foam. The HD foam provides worse support because the HD foam creates a hammocking feeling of being pulled at the point of contact with the support surface. The surface of the HD foam extending away from the cylinder is closer to a straight line than is the surface of the memory foam. FIG. 3C illustrates that the 12-pound, 8-inch cylinder would sink about 33% into the thickness of the memory foam if the cylinder were warmed to body temperature and allowed to sit for several minutes. Thus, with the effects of body temperature, the memory foam of second lateral region 19 has an effective ILD of ten and is softer than the adjacent lateral regions 18 and 20.

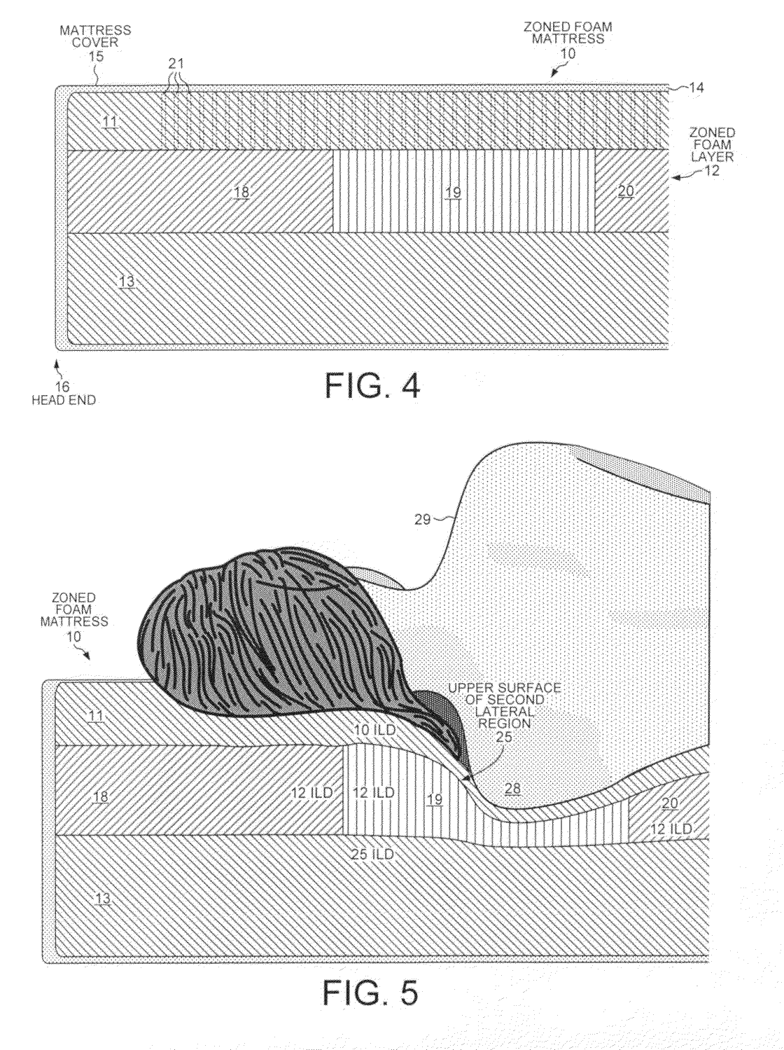

FIGS. 4-5 provide more detailed cross-sectional views of zoned foam mattress 10 showing the lateral regions towards head end 16 of the mattress. Second lateral region 19 is positioned to lie between and longitudinally abuts first lateral region 18 and third lateral region 20. FIG. 4 shows vertical holes 21 that pass entirely through upper foam layer 11. In other embodiments, the holes 21 penetrate only part way into upper foam layer 11. FIG. 5 shows how a person's shoulder sinks into and is supported by the lateral regions shown in the unoccupied mattress of FIG. 4. The lateral regions 18-20 of FIGS. 4-5 all have a 25%-compression ILD of twelve. Upper foam layer 11 has a 25%-compression ILD of ten. And bottom foam layer 13 has a 25%-compression ILD of twenty-five. FIG. 5 shows that the shoulder 28 of a woman 29 sinks far into second lateral region 19 after the memory foam of lateral region 19 has warmed to body temperature. In addition, the upper surface 25 of the memory foam of second lateral region 19 curves to hug shoulder 28. Softer upper foam layer 11 with vertical holes 21 compresses significantly between the weight of shoulder 28 and second lateral region 19.

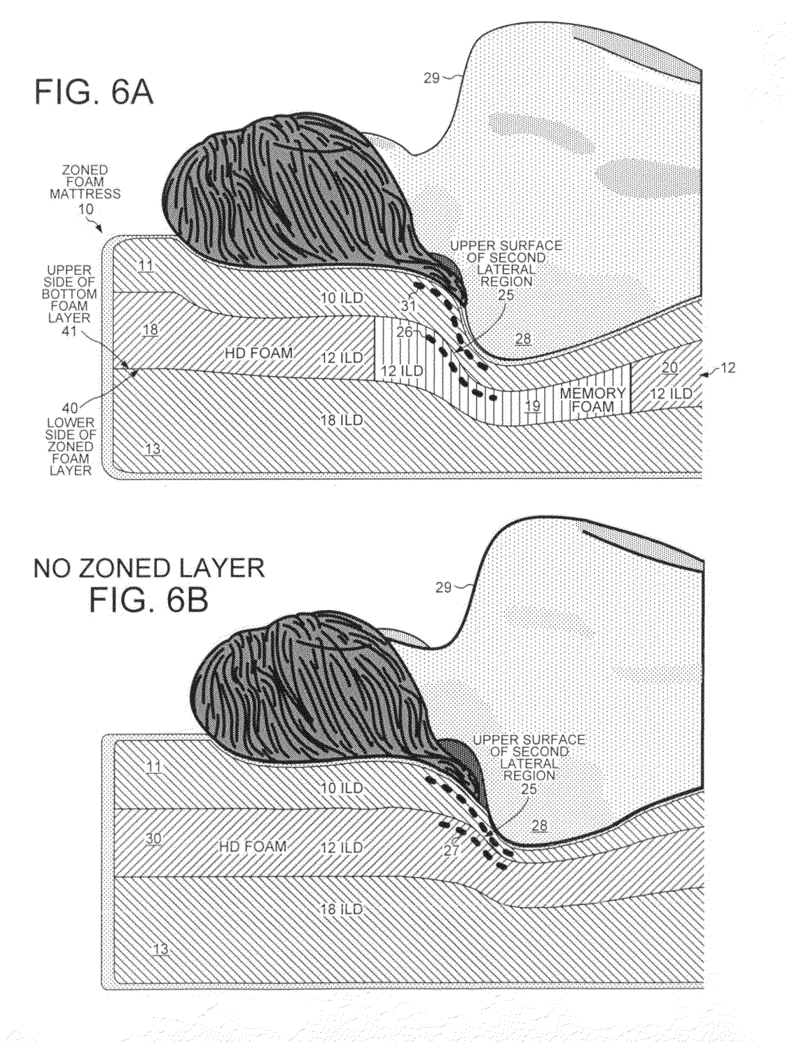

FIGS. 6A-B compare the characteristics of zoned foam mattress 10 to the characteristics of a mattress in which the second foam layer is made entirely of HD foam. The bottom layers of exemplary mattresses of FIGS. 6A-B are softer than a typical consumer would prefer in order to accentuate the different response of a layer of HD foam having a specified ILD and a layer of alternating HD and memory foam regions in which all of the lateral regions have that same specified ILD. Nevertheless, mattresses for all consumer preferences should have bottom foam layers 13 with a higher ILD than the ILD of the lateral regions of zoned foam layers 12. The higher ILD of bottom foam layer 13 provides better support to zoned foam layer 12 and upper foam layer 11.

FIG. 6A is a cross-sectional view of zoned foam mattress 10 in which first and third lateral regions 18 and 20 are formed from high-density polyurethane foam, whereas second lateral region is formed from visco-elastic polyurethane foam. In the mattresses of both FIGS. 6A and 6B, upper foam layer 11 has a 25%-compression ILD of ten, whereas bottom foam layer 13 has a 25%-compression ILD of eighteen. The lateral regions 18-20 of FIG. 6A all have a 25%-compression ILD of twelve. The mattress of FIG. 6B has a middle foam layer 30 of HD foam with a 25%-compression ILD of twelve.

FIG. 6A shows that the shoulder 28 of the woman 29 sinks farther into second lateral region 19 of mattress 10 than into middle foam layer 30 of the mattress of FIG. 6B, despite both region 19 and layer 30 having the same ILD. The pointed shoulder 28 sinks deeper into the memory foam of region 19 than into the HD foam of layer 30. And after the memory foam of lateral region 19 has warmed to body temperature, shoulder 28 sinks deeper into the memory foam than into HD foam of the same ILD hardness. There is a greater curvature 26 in the upper side 25 of second lateral region 19 than the curvature 27 in the upper surface of the HD foam layer 30. Consequently, upper foam layer 11 hugs shoulder 28 closer and provides better support above the memory foam of region 19 than above the HD foam of layer 30. Upper foam layer 11 of zoned foam mattress 10 provides a closer contour 31 to the neck and shoulder 28 than does upper foam layer 11 in the mattress of FIG. 6B.

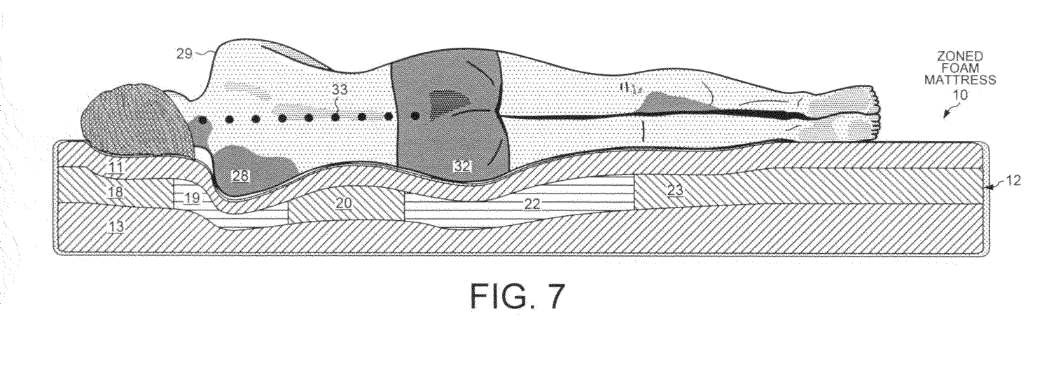

FIG. 7 is a cross sectional view of the entire zoned foam mattress 10 of the embodiment of FIG. 6A. FIG. 7 illustrates how mattress 10 permits a person's spine to remain straight when the shoulders and hips can sink farther into the mattress. In order to achieve spinal alignment, the supporting forces of the mattress, under the load of a reclining body, must vary along the body to match the body density and shape. Nevertheless, the supporting pressures of the mattress against the skin must be even over the entire body in order for the mattress to be comfortable. A straight side-lying spinal alignment of a reclining person is generally considered to be that alignment in which the spine is straight and on the same center line as the legs and head.

The temperature sensitivity of the memory foam of lateral regions 19 and 22 imparts a lower effective indentation load deflection (ILD) to regions 19 and 22 that allows the shoulders 28 and hips 32 of person 29 lying on his or her side to sink into mattress 10 so as to keep the curve 33 of the person's spine straight and on the same center line as the legs and head. In addition, the point of shoulder 28 can sink farther into memory foam than into HD foam of the same ILD. The HD foam of the remaining lateral regions 18, 20 and 23 deforms to a lesser extent under the weight of the person's head, torso and legs. Thus, zoned foam mattress 10 provides variable support that maintains the natural curvature of the body consistent with kinesiology and effectively enhances the degree of comfort for the body portions in contact with the mattress. In addition, the temperature sensitivity of the memory foam of lateral regions 19 and 22 also reduces the pressure points that are more likely to develop under the shoulders and hips above the HD foam of layer 30, thus increasing support and comfort. In order to enhance the degree to which a person's shoulders and hips sink into lateral regions 19 and 22, in addition to making those regions from memory foam, those regions can also be made with foam having a lower ILD than the remaining lateral regions 18, 20 and 23.

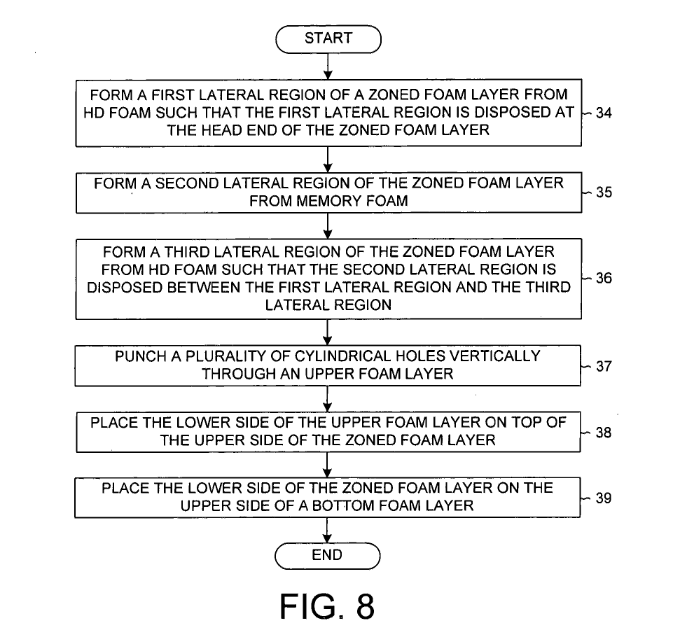

FIG. 8 is a flowchart illustrating steps 34-39 of a method of making zoned foam mattress 10 that can provide variable support so as to maintain a straight spine of a person sleeping on the mattress. In a first step 34, first lateral region 18 of zoned foam layer 12 is formed from high-density (HD) foam. In step 35, second lateral region 19 is formed from visco-elastic polyurethane (memory) foam. In step 36, third lateral region 20 is formed from HD foam such that second lateral region 19 is disposed between first lateral region 19 and third lateral region 20. First lateral region 18 is disposed at the head end of zoned foam layer 12 and mattress 10. In step 37, a plurality of cylindrical holes 21 are punched vertically through upper foam layer 11. The holes 21 cover the entire surface of upper foam layer 11 except for a band around the perimeter of layer 11 that is several inches wide. In step 38, the lower side 24 of upper foam layer 11 is placed on top of the upper side 25 of zoned foam layer 12. In step 39, the lower side 40 of zoned foam layer 12 is placed on top of the upper side 41 of bottom foam layer 13.

Although certain specific embodiments are described above for instructional purposes, the teachings of this patent document have general applicability and are not limited to the specific embodiments described above. Although the alternating lateral zones of HD foam and memory foam are described above as forming a zoned foam layer of a mattress, the lateral zones of HD foam and memory foam can also be used to make mattress toppers. Accordingly, various modifications, adaptations, and combinations of various features of the described embodiments can be practiced without departing from the scope of the invention as set forth in the claims.

What is claimed is:

1. A mattress comprising:
an upper foam layer with a lower side; and
a zoned foam layer with an upper side and a head end, wherein the lower side of the upper foam layer is adjacent to the upper side of the zoned foam layer, wherein the zoned foam layer has a first lateral region, a second lateral region and a third lateral region, wherein the first lateral region is disposed at the head end of the zoned foam layer, wherein the second lateral region is disposed between the first lateral region and the third lateral region, wherein the first and third lateral regions are formed from high-density polyurethane foam, and wherein the second lateral region is formed from visco-elastic polyurethane foam.

2. The mattress of claim 1, wherein each of the first, second and third lateral regions has the same indentation load deflection (ILD).

3. The mattress of claim 1, wherein the second lateral region has a lower indentation load deflection (ILD) than do the first lateral region and the third lateral region.

4. The mattress of claim 1, further comprising:
a bottom foam layer upon which the zoned foam layer rests, wherein the bottom foam layer has a higher indentation load deflection (ILD) than does the first lateral region.

5. The mattress of claim 1, wherein the second lateral region is adapted to allow a person's shoulders to sink into the mattress so as to keep the person's spine straight.

6. The mattress of claim 1, wherein the second lateral region is adapted to support the shoulders of a person reclining on the mattress.

7. The mattress of claim 1, wherein a plurality of cylindrical holes are distributed throughout the upper foam layer.

8. The mattress of claim 7, wherein the cylindrical holes pass entirely through the upper foam layer.

9. The mattress of claim 1, further comprising:
a mattress cover adapted to allow a user to lie over the mattress cover directly on the upper foam layer.

10. A method comprising:
forming a first lateral region of a zoned foam layer, wherein the zoned foam layer has an upper side and a head end;
forming a second lateral region of the zoned foam layer, wherein the second lateral region is formed from visco-elastic polyurethane foam;
forming a third lateral region of the zoned foam layer, wherein the first and third lateral regions are formed from high-density polyurethane foam; and
placing a lower side of an upper foam layer on top of the upper side of the zoned foam layer, wherein the first lateral region is disposed at the head end of the zoned foam layer, and wherein the second lateral region is disposed between the first lateral region and the third lateral region.

11. The method of claim 10, wherein each of the first, second and third lateral regions has the same indentation load deflection (ILD).

12. The method of claim 10, wherein the zoned foam layer has a lower side, further comprising:
placing the lower side of the zoned foam layer on an upper side of a bottom foam layer.

13. The method of claim 10, wherein the second lateral region is adapted to allow a person's shoulders to sink into the mattress so as to keep the person's spine straight.

14. The method of claim 10, further comprising:
punching a plurality of cylindrical holes vertically through the upper foam layer.

15. The method of claim 10, wherein the second lateral region is formed from heat sensitive foam.

16. A mattress comprising:
an upper foam layer with a lower side;
a first zone of a zoned foam layer, wherein the lower side of the upper foam layer is adjacent to an upper side of the zoned foam layer;
a second zone of the zoned foam layer; and
means for allowing a person's shoulder to sink farther into a shoulder zone of the zoned foam layer than into the first zone or the second zone, wherein the shoulder zone lies between the first zone and the second zone, and wherein the first zone, the second zone and the shoulder zone all have the same indentation load deflection (ILD).

17. The mattress of claim 16, wherein all parts of the upper foam layer exhibit the same indentation load deflection (ILD).

18. The mattress of claim 16, wherein the means allows the person's shoulder to sink into the shoulder zone such that the person's spine is kept straight.

19. The mattress of claim 16, wherein the first zone and the second zone are made of HD foam.

20. The mattress of claim 16, wherein the means is made of heat sensitive foam.
